(19) United States
(12) Patent Application Publication
(10) Pub. No.: US 2010/0181341 A1
(43) Pub. Date: Jul. 22, 2010

(54) Cold block with integral beer tap

(75) Inventor: Jon Joseph Robinson, Lakewood, CO (US)

Correspondence Address: Jon Robinson, 13969 W. Harward Ave, Lakewood, CO, 80228, US

(73) Assignee: Bruce Kirsh baum

(21) Appl. No.: 12/321,341

(22) Filed: Jan. 17, 2009

(51) Int. Cl. B67D 5/62

(52) U.S. Cl. 222/146.6

(57) ABSTRACT

The present invention teaches a beverage tower of the type having a cold block with glycol recirculation, however, the traditional tap is actually built into the cold block, so as to keep the entire beer tap or other type of tap cold and maintain the beverages in a sanitary condition meeting health codes. The glycol lines within the cold block are then arranged so as to pass around the tap in the cold block, resulting in a tap which remains cooled so long as the glycol recirculation system keeps the block cold. Serpentine channels may be used so that the beverage passing through the beverage supply channels has a longer run in contact with the conductive material of the cold block and thus more opportunity to reject heat thereinto.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to beverage, especially beer towers, and specifically to cold blocks in beverage towers.

### STATEMENT REGARDING FEDERALLY FUNDED RESEARCH

This invention was not made under contract with an agency of the US Government, nor by any agency of the US Government.

### BACKGROUND OF THE INVENTION

In beverage dispensing technology, it is imperative for both sanitary and regulatory reasons to maintain low temperatures in the product being dispensed. Different products have different regulatory standards, for example, NSF 18 is applicable to beer technology, while NSF 20 is applicable to milk dispensing.

A typical beer dispensing tower is shown in FIG. 1, a type which might be manufactured by Perlick or any other manufacturer for many years. The tower 102 has a top 104 and a tap 106. Tap 106 projects out from the side of the tower top 104, on extension 116. A shank screw (not seen) is embedded inside. Tap handle 114 includes an internal faucet lever that is attached to an internal valve stem having at least two positions (forward/open and backward/closed), and thus allows beer or other beverages to be dispensed from orifice 112, due to the presence of the internal valve. Note that the valve usually (in most designs) cuts off flow at 110, which is the rear of the faucet, and the location of the valve seat, and so the beverage which is held within the system is not inside the tap 106 but rather is entirely within the tower (102/104) and any beverage within the tap 106 will drain out immediately after the tap is closed. This is important as there is a “cold block” 120 contained within the tower. The cold block keeps the beer or other beverage cold as the beer stops at the valve seat at the intersection of 110 and 120. (The tap 106, however, essentially only receives a minimum of cooling by conduction from cold block 120 through the stem 110/116.)

Thus standard designs do not hold beer within the faucet body 116: there is no beer at 108 and the point of dispense is functionally at 110.

In other designs such as the Perlick “sanitary faucet” or stout faucets, the valve is reversed and beverage remains within the faucet, attempting to rely upon the conduction from the cold block to keep the external faucet cold.

The prior art cold block as used for many decades is a conductive block with channels running through it. The channels carry glycol coolant, which is kept separated from one or more product channels carrying the beverage: beer, milk, and so on. The channels of glycol can absorb large amounts of heat and carry it away to a heat exchanger such as a radiator located at a remote location. The aluminum cold block has excellent heat transmission properties, heat rejected by the beverage as it passes through the cold block can easily enter the cold block and then be rejected into the glycol and away. If the valve 110 is located projecting into the heat block 120 (as some products by Perlick and others have had for 50 years or more) then the traditional arrangement keeps the beverage cold right to the point of dispense at valve part 110. The glycol channels in the prior art arrangements may run throughout cold block 120 in any of a wide range of ways, for example, the glycol channels may run right to the point of dispense at valve part 110 (except of course Perlick sanitary faucets, etc).

Other systems teach using glycol lines to cool the feed lines running up to the valves but with no true cold block (as in soft drink fountain systems).

Various types of systems have been proposed.

U.S. Pat. Nos. 7,188,751 and 7,140,514 issued Mar. 13, 2008 and Nov. 28, 2006 to Van Der Klaauw et al, U.S. Pat. No. 6,360,556 issued Mar. 26, 2002 to Gagliano, U.S. Pat. No. 6,237,652 issued May 29, 2001 to Nelson, U.S. Pat. No. 5,873,259 issued Feb. 23, 1999 to Spillman, U.S. Pat. No. 5,694,787 issued Dec. 9, 1997 to Cleleand et al, U.S. Pat. No. 5,537,825 issued Jul. 23, 1996 to Ward, U.S. Pat. No. 4,094,445 issued Jun. 13, 1978 to Bevan, U.S. Pat. No. 2,450,315 issued Sep. 29, 1948 to Vetrano, U.S. Pat. No. 2,286,205 issued Jun. 16, 1942 issued to Grubb, U.S. Pat. No. 2,259,852 issued Oct. 21, 1941 to Hall show some typical examples of the prior art in the field.

U.S. Pat. No. 7,272,951 issued Sep. 25, 2007 to Kyees teaches that the cooling lines in a cold block may pass about the tap shank and sockets fittings (not the tap heads themselves). The tap heads still project from the tower, as may be seen in FIG. 14b of the reference.

However, it is not generally known to actually place the traditional beer tap into the cold block itself, then run coolant lines all the way around the tap while staying entirely within the cold block.

It would be desirable to provide a device which allows beverages to be maintained at a low temperature until the actual tap itself, by placing the taps within the cold block.

### SUMMARY OF THE INVENTION

General Summary

Thus the present invention teaches a beverage tower of the type having a cold block with glycol recirculation, however, the traditional tap does not project from the block but rather is actually built into the cold block, so as to keep the entire beer/beverage tap cold. By contrast, traditional systems have one end of the tap or the valve seat of the tap located just beyond the cold block. The present invention teaches that the entire tap (with the exception of parts such as a handle or a self-draining nozzle orifice) may be located within the cold block. Beverage passing through the cold block thus is cooled and kept cold while waiting in the block. Cooling has been shown to slow bacterial growth. This is important for beverages which must be kept cold at all times so as to maintain sanitary conditions and assist maintenance of sanitary conditions for the beverage, in keeping with food safety codes.

Tested versions with straight beverage supply lines passing through the cold block to a tap entirely within the cold block have passed NSF 18.

The glycol lines within the cold block may optionally be arranged so as to pass around the tap in the cold block, even around the entire tap, with a 360 degree envelopment on all sides. This results in the tap remaining cooled so long as the glycol recirculation system keeps the block in which it is embedded cold.

Serpentine beverage supply channels (and of course glycol channels as well) may be employed so that the beverage passing through the beverage supply channels has a longer run and longer time in contact with the cooled conductive material of the cold block, though the invention is about the location of the tap and the ability to better cool beverages, not the serpentine channels. This provides more time and contact opportunity to reject heat from the beverage to the block and assist in maintaining sanitary conditions for the beverage.

Heat rejected from the beverage into the block is then of course rejected again into the glycol in the glycol channels (which are entirely sealed from the beverage channels) and carried away by a glycol recirculation pump back to the glycol storage bath within the glycol refrigeration unit.

Summary in Reference to Claims

It is therefore another aspect, advantage, objective and embodiment of the invention, in addition to those discussed previously, to provide a beverage dispensing device comprising:
a cold block having a body made of a heat conducting material;
at least one tap, the tap disposed within the cold block;
at least one beverage channel passing through the cold block to the at least one tap;
at least one coolant channel passing through the cold block to the at least one tap and passing about the tap within the cold block.

It is therefore another aspect, advantage, objective and embodiment of the invention to provide a beverage dispensing device wherein the beverage channel is serpentine within the cold block.

It is therefore another aspect, advantage, objective and embodiment of the invention to provide a beverage dispensing device wherein the coolant channel is serpentine within the cold block.

It is therefore another aspect, advantage, objective and embodiment of the invention to provide a beverage dispensing device further comprising:
a beverage tower, the cold block disposed within the beverage tower.

It is therefore another aspect, advantage, objective and embodiment of the invention to provide a beverage dispensing device wherein the cold block heat conducting material is aluminum.

It is therefore another aspect, advantage, objective and embodiment of the invention to provide a beverage dispensing device further comprising:
a second tap disposed within the cold block;
a second beverage channel passing through the cold block to the second tap;
the at least one coolant channel passing through the cold block to the at second tap and passing about second tap within the cold block

And it is another aspect, advantage, objective and embodiment of the invention to provide a beverage dispensing device further comprising:
a glycol return allowing glycol in the cold block to recirculate.

It is therefore another aspect, advantage, objective and embodiment of the invention to provide a beverage dispensing device further comprising:
a glycol cooling and recirculation unit.

It is therefore yet another aspect, advantage, objective and embodiment of the invention to provide a beverage dispensing device further comprising:
first and second beverage supplies.

It is therefore another aspect, advantage, objective and embodiment of the invention to provide a beverage dispensing device wherein the first and second beverage supplies further comprise containers having therein one member selected from the group consisting of: carbonated and non-carbonated beer, other alcoholic beverages, syrups, water, milk, fruit juice and combinations thereof.

### BRIEF DESCRIPTION OF THE DRAWINGS

FIG. 1 is a partially transparent side view of a PRIOR ART beverage dispensing tower, such as has been on the market for many years, showing a typical cold block arrangement in a tower head.

FIG. 2 is a top planform view of a single product beverage channel of the cold block of the present invention.

FIG. 3 is a transparent top planform view of a cold block incorporating the taps therein, as well as the channel of FIG. 2 and another mirror image channel displaced slightly below or above the first channel.

FIG. 4 is a top planform view of a single glycol cooling channel of the cold block of the present invention.

FIG. 5 is a transparent top planform view of a cold block of the invention showing the glycol cooling channel, the beverage channels and the taps all within the cold block.

FIG. 6 is a transparent side view of portions of a beverage dispensing tower incorporating the cold block of the invention therein.

FIG. 7 is a partially transparent side view of a system embodiment of the invention, showing beverage supplies, glycol recirculation and the like.

FIG. 8 is a block diagram of a system of different types of dispensing towers, glycol cooling/pumping devices, beverage supplies, supply lines and so on.

### INDEX TO REFERENCE NUMERALS

Tower 102
Tower top 104
Tap 106
Valve section 108
Valve section 110
Orifice 112
Tap handle 114
Extension 116
Cold block 120
Tower 602
Tower top 604
Tap 612
Cold block 620
Beverage feed line 670
Glycol feed line 672
Glycol return line 673
Beverage cooling channels 674
Beverage cooling channels 675
Glycol channels 676
First beverage supply 680
Second beverage supply 682
Glycol recirculation unit 684
First beverage feed 686
Second beverage feed 688
Beverage dispensing towers 702a, 702b, 702c, 702d
Supply lines 704
Beverage supplies 706a, 706b, 706c
Pumping/cooling unit 708

### DETAILED DESCRIPTION

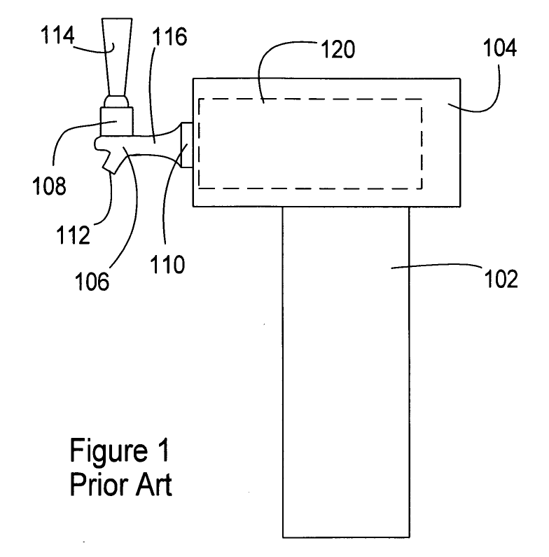

FIG. 1 is a partially transparent side view of a PRIOR ART beverage dispensing tower 102, such as has been on the market for many years, showing a typical cold block arrangement in a tower head 104.

Tower 102 typically projects upward above a work surface such as a bar or counter, with a drain or catch basin below. Tower top 104 projects out from tower 102, then tap 106 projects out from the top 104 further on extension section 116.

Valve section 108 meets handle 114 and allows motion of the handle 114 to actuate a valve within the tap 106. The operative valve seat may be within section 108 or elsewhere. In some prior art arrangements, the valve section 110 has the valve seat, so the valve actually seals at that location when the tap handle 114 is released. Valve section 110 seats directly into a cold block 120 within the head 104. This means that when the tap handle 114 is released and the valve closes, beverage within the tower head 104 is contained and cooled within the cold block 120, while beverage which has passed the valve section 110, for example inside of extension 116, but is still within the tap 106 will quickly drain out of the tap 106 by orifice 112, leaving the interior of the tap substantially empty of beverage. These measures allow the device to pass food safety codes.

In devices in which the valve seat is located nearer to the orifice 106 or valve section 108, the extension can keep beverage cool for a period of time, but not as effectively as the beverage within the cold block 120 is cooled.

Cold block 120 will have glycol channels within it according to prior art, but note that the tap 106 projects far beyond the confines of the cold block 120.

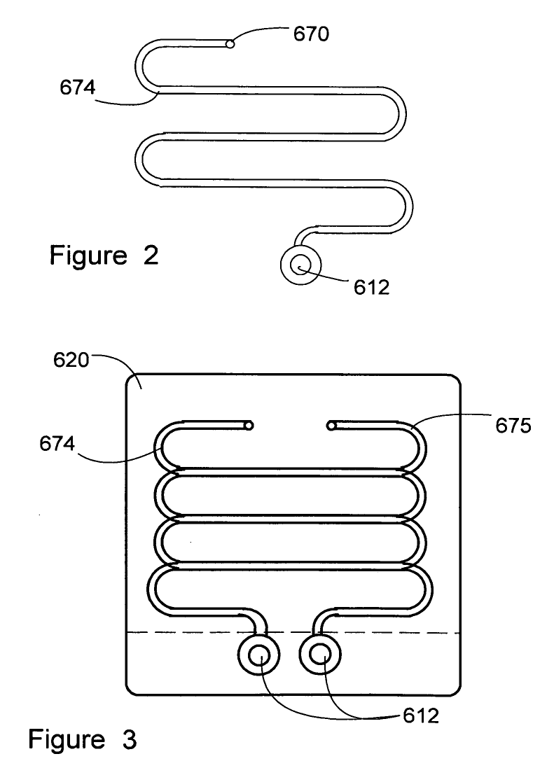

FIG. 2 is a top planform view of a single product beverage channel of the cold block of the present invention. Tap 612 is fed by a beverage cooling channel 674 which is in turn fed from beverage feed 670. It is useful to see this shape in isolation so as to see it clearly before putting all of the channels in the cold block of the invention into a single diagram. Note that the channels are not the key to the invention, which is about the tap location and the ability to better cool beer.

FIG. 3 is a transparent top planform view of a cold block incorporating the taps therein, as well as the channel of FIG. 2 and another mirror image channel 675 displaced slightly below or above the first channel. Note that both of the channels shown are actually beverage channels, that is, neither channel is a glycol channel. In the embodiments shown, the cooling channels are disposed superimposed above the beverage channels 674, 675 and all channels are within the cold block. Taps 612 are fed by the beverage channels, which are “dispense only” channels during normal operation.

Moving the taps to a location inside the cold block allows vastly superior cooling of the beverage and thus more sanitary conditions.

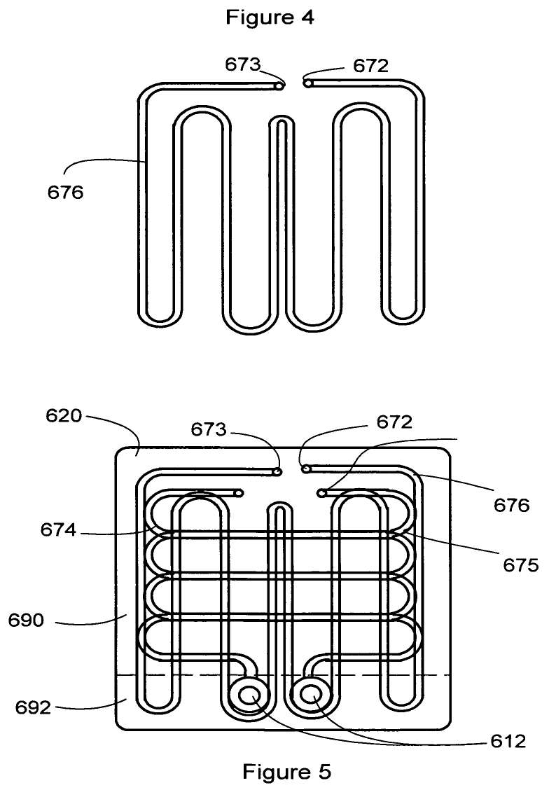

FIG. 4 is a top planform view of a single glycol cooling channel of the cold block of the present invention. Glycol feed line 672 and glycol return line 673 are connected by serpentine glycol channel(s) 676, so glycol within the channel will recirculate, entering at 672 and leaving at 673.

FIG. 5 is a transparent top planform view of a cold block of the invention showing the glycol cooling channel, the beverage channels and the taps all within the cold block. It may be useful to compare FIGS. 2 through 4 with FIG. 5. In the presently preferred embodiment and best mode presently contemplated for carrying out the invention, the channels are disposed superimposed (in planform view) within the cold block 120, thus providing are large degree of heat conduction between the beverage channels and the glycol channels.

Taps 612 are, according to the presently preferred embodiment, disposed and manufactured into cold block 620. Note that a small orifice at the bottom and an actuator, button, lever or traditional tap handle may project, however, the actual body of the tap is within the cold block. Beverage feed line 670 may be seen, as may glycol feed line 672 and glycol return line 673. Beverage feed line 670 allows beverage to enter beverage cooling channels 674, while beverage cooling channels 675 may also be seen in the drawing. The channels 674 and 675 may in fact dispense different products from different taps, or may have the same product for two different taps, or may even meet to dispense a combined beverage (such as a liquid drink syrup and CO₂ (soda) water, which form components of a single soda fountain drink) from a single tap. The range of beverages dispensable includes not only traditional beer drinks (the present invention relates to traditional beer tower/tap systems and largely uses beer components), but also other alcoholic beverages, milk, syrups, waters, (carbon dioxide or filtered air, though they are not beverages) fruit and vegetable drinks, processed drinks, mixed drinks, manufactured drinks and so on.

Glycol channels 676 are sealed from the beverage channels and cannot cross connect with beverages.

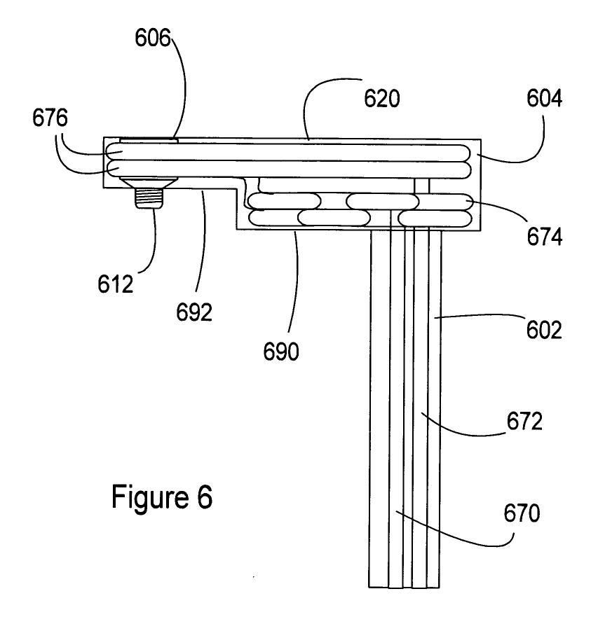

FIG. 6 is a transparent side view of portions of a beverage dispensing tower incorporating the cold block of the invention therein.

Tower 602 has projecting tower top 604, which along with cold block 620 is shown transparent for clarity. Tap 606 may be seen within cold block 620. Beverage line 674 is shown within the solid aluminum cold block 620, below glycol lines 676 which are also within the cold block 620. Feed lines 670 for beverage and 672 for glycol are shown. Beverage thus travels up the tower 602, enters the block 620 and is cooled (or is held cool during times beverage is not flowing) within the cold block 620.

Orifice 612 may be seen to be projecting slightly from the bottom of the block, and an actuator such as a beer tap handle (not shown) may be project from the top of the cold block, but the actual beverage/valve portions of the tap are entirely located within the cold block.

The cold block need not be a simply prism shape but rather may be any shape, in fact, it may be shaped into shapes such as the shape of a traditional beer tap or another shape.

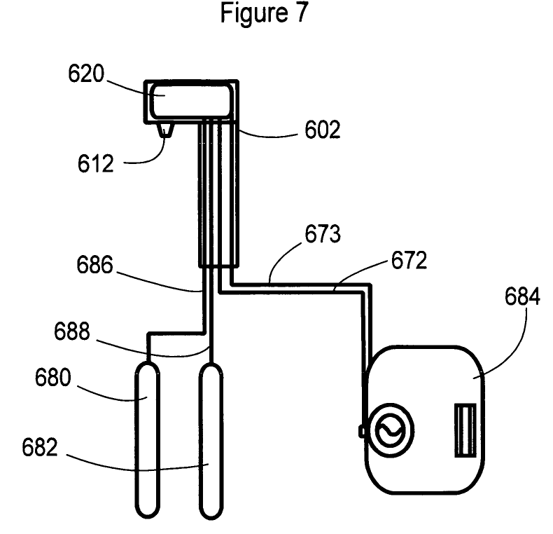

FIG. 7 is a partially transparent side view of a system embodiment of the invention, showing beverage supplies, glycol recirculation and the like.

The overall system includes first beverage supply 680, which may be a keg, bag-in-box, pressurized and non-pressurized stainless steel beverage containers, or the like, second beverage supply 682, glycol recirculation unit 684, first beverage feed 686, second beverage feed 688 and other components as desired, such as a body, a counter top, and so on. Glycol recirculation unit 684 normally comprises a pump and cooling apparatus but may include other features as necessary.

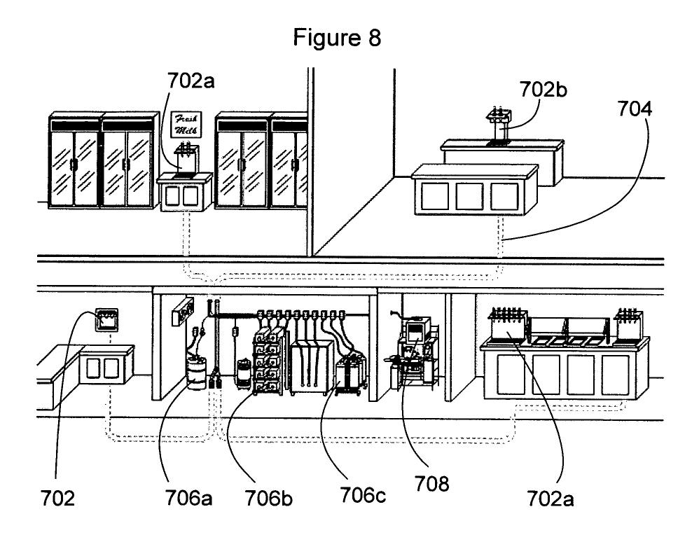

FIG. 8 is a block diagram of a system of different types of dispensing towers, glycol cooling/pumping devices, beverage supplies, supply lines and so on.

Beverage dispensing towers 702a, 702b, 702c, 702d may be seen to be in a number of locations and of a number of types, ranging from 2 taps up to 6 (and there may be 10 or more), located built into walls, on bars and cabinets, in kitchens and so on and so forth. Supply lines 704 connect the towers to a number of different beverage supplies 706a, 706b, 706c and it may be seen that the system may be used to provide different beverages to different locations. Pumping/cooling unit 708 may provide the cooling of glycol, which is necessary to maintain a cold and thus sanitary system.

The disclosure is provided to render practicable the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A beverage dispensing device comprising:
a cold block having a body made of a heat conducting material;
at least one tap, the tap disposed within the cold block;
at least one beverage channel passing through the cold block to the at least one tap;
at least one coolant channel passing through the cold block to the at least one tap and passing about the tap within the cold block.

2. The beverage dispensing device of claim 1, wherein the beverage channel is serpentine within the cold block.

3. The beverage dispensing device of claim 1, wherein the coolant channel is serpentine within the cold block.

4. The beverage dispensing device of claim 1, further comprising:
a beverage tower, the cold block disposed within the beverage tower.

5. The beverage dispensing device of claim 1, wherein the cold block heat conducting material is aluminum.

6. The beverage dispensing device of claim 1, further comprising:
a second tap disposed within the cold block;
a second beverage channel passing through the cold block to the second tap;
the at least one coolant channel passing through the cold block to the at second tap and passing about second tap within the cold block

7. The beverage dispensing device of claim 6, further comprising:
a glycol return allowing glycol in the cold block to recirculate.

8. The beverage dispensing device of claim 7, further comprising:
a glycol cooling and recirculation unit.

9. The beverage dispensing device of claim 8, further comprising:
first and second beverage supplies.

10. The beverage dispensing device of claim 9, wherein the first and second beverage supplies further comprise containers having therein one member selected from the group consisting of: carbonated and non-carbonated beer, other alcoholic beverages, syrups, water, milk, fruit juice and combinations thereof.
